(19) United States
(12) Patent Application Publication
(10) Pub. No.: US 2017/0276244 A1
(43) Pub. Date: Sep. 28, 2017

(54) Torque Converter Device And Method For Controlling A Fluid Circuit Of A Torque Converter Device

(71) Applicant: ZF Friedrichshafen AG, Friedrichshafen (DE)

(72) Inventors: Frank STÜTZINGER, Geldersheim (DE); Axel ROHM, Schonungen (DE); Christian WEBER, Ebersburg (DE); Georg SCHWARZ, Gundelsheim (DE)

(21) Appl. No.: 15/510,946

(22) PCT Filed: Aug. 13, 2015
(86) PCT No.: PCT/EP2015/068622

§ 371 Date: Mar. 13, 2017

(30) Foreign Application Priority Data
Sep. 16, 2014 (DE) 102014218 555.6

(51) Int. Cl. F16H 61/50; F16H 61/00

(52) U.S. Cl. CPC F16H 61/50; F16H 61/0021; F16H 2045/0215

(57) ABSTRACT

A torque converter device and to a method for controlling a liquid circuit of a torque converter device. The torque converter device includes a housing arrangement and a hydrodynamic device arranged in the housing arrangement. The hydrodynamic device include an impeller wheel connected on the input side to a driveshaft via the housing arrangement, a turbine wheel connected to an output shaft, and a stator wheel. The wheels collectively form a circuit filled with a liquid, that can be supplied with liquid by an external supply device. The torque converter device is constructed such that it actuates at least one flow control element for controlling the flow of liquid for the torque converter device in the circuit actively and/or passively depending on a difference in speed between the impeller wheel and the turbine wheel of the hydrodynamic device.

### CROSS REFERENCE TO RELATED APPLICATIONS

This is a U.S. national stage of application No. PCT/EP2015/068622, filed on Aug. 13, 2015. Priority is claimed on German Application No. DE102014218555.6, filed Sep. 16, 2014, the content of which is incorporated here by reference.

### BACKGROUND OF THE INVENTION

### 1. Field of the Invention

The invention is directed to a torque converter device comprising a housing arrangement and a hydrodynamic device arranged in the housing arrangement the hydrodynamic device comprises an impeller wheel connected on the input side to a driveshaft via the housing arrangement, a turbine wheel that can be connected to an output shaft, and a stator wheel, the wheels collectively form a circuit filled with a liquid, in particular the circuit can be supplied with liquid by an external supply device.

The present invention is likewise directed to a method for controlling a liquid circuit of a torque converter device.

### 2. Description of Prior Art

Conventional torque converter devices comprise a hydrodynamic arrangement of a known type having a stator wheel, a turbine wheel and an impeller wheel. The stator wheel is formed so as to be fixed with respect to the transmission housing via a stator wheel support so as to block in one rotating direction and so as to rotate along with a freewheel in another rotating direction. The stator wheel support is fixedly connected to the transmission housing. Control of the coolant oil flow of the torque converter, also designated hereinafter as converter for the sake of brevity, is carried out via the hydraulic circuit of the transmission through the transmission control device or the transmission oil pump. A drawback consists in that the supply lines to the converter cannot be varied, and the flow resistance is constant and cannot be influenced. Therefore, the transmission oil pump is designed in such a way that an assumed worst case scenario for the cooling is also covered.

It has been suggested in U.S. Pat. No. 4,049,093 to arrange a second valve in the circuit such that this second valve can control the inflow to the space between the housing and piston of a torque converter lockup arrangement. For actuating inlet and outlet, a two-way reversing valve is usually arranged that can control the two lines for purposes of inflow or outflow as needed. It is disadvantageous that the valve is passively controlled based on the direction of the flow of liquid provided through the two-way valve. Consequently, it is disadvantageous that flexibility is substantially limited. Further, control is effected through the two-way valve and pump arranged external to, i.e., outside of, the circuit.

A hydrodynamic torque converter with lockup clutch is known from DE 44 23 640 A1. The pump for the hydraulic circuit is driven via the impeller wheel and a pipe connected to the latter. In order to improve the flow of hydraulic liquid, the oil is guided when flowing radially inward so as to mitigate effects in the flowing oil based on Coriolis force.

DE 199 09 349 A1 shows a further hydrodynamic torque converter. Depending on an external switching valve and with the aid of a pump, bore holes, namely an axial bore hole on the one hand and an annular channel on the other hand, can admit hydraulic liquid. The switching valve takes on the function of switching the bore hole and channel, respectively, as inlet or outlet. On the side facing the input of the transmission, the axial bore hole has an insert body in the transition to the pressure space between housing and piston of a lockup clutch for a hydrodynamic device, which insert body is conical overall but has a lateral surface concave in axial section. This insert body can also be formed so as to be mounted to the converter housing. By this insert body, the hydraulic liquid can flow between the axial bore hole and the piston space in a fluidically advantageous manner and without forming some kind of dead water zones with lower flow losses. The pump is connected to the impeller wheel in a conventional manner by a connection device in order to drive the impeller wheel.

However, all of the torque converters mentioned above have the disadvantage that the pump capacity must be designed for the worst case scenario for cooling. It is further disadvantageous that this causes a high power consumption and the pump accordingly operates inefficiently in many operating ranges. A further disadvantage consists in that the high dynamics of the hydraulic liquid in the converter circuit caused by the high pump capacity can lead to a strong “self-pumping”, which manifests itself particularly through a correspondingly high pressure increase in the inlet line. Ensuring the required volume flow of coolant oil, hydraulic liquid, etc., accordingly requires a high supply pressure, which increases costs and the installation space of the torque converter.

### SUMMARY OF THE INVENTION

One object of the present invention is to provide a mom efficient hydraulic supplying of the transmission, particularly of the converter circuit. One object of the present invention is to reduce the power consumption of the pump for the hydraulic liquid and to increase flexibility, i.e., to ensure that the torque converter is supplied with hydraulic liquid to meet demands and, further, to provide this substantially without increasing installation space and in an economical manner.

In a torque converter device comprising a housing arrangement a hydrodynamic device arranged in the housing arrangement, wherein the hydrodynamic device comprises an impeller wheel connected on the input side to a driveshaft via the housing arrangement, a turbine wheel which can be connected to an output shaft, and a stator wheel, and wherein the wheels collectively form a circuit filled with a liquid, in particular wherein the circuit can be supplied with liquid by an external supply device, the present invention meets the above-stated in that the torque converter device is constructed in such a way that it actuates at least one flow control element for controlling the flow of liquid for the torque converter device in the circuit actively and/or passively depending on a difference in speed between the impeller wheel and the turbine wheel of the hydrodynamic device.

The above-stated objects are also met by one aspect of the present invention through a method for controlling a liquid circuit of a torque converter device, in that the hydrodynamic device actuates at least one flow control element for controlling the liquid flow for the torque converter in the circuit actively and/or passively depending on a difference in speed between the impeller wheel and the turbine wheel of the hydrodynamic device.

One of the advantages achieved by this is that a hydraulic liquid control that meets demands is enabled by at least one flow control element for controlling the flow of liquid within the circuit. Additional, uneconomical control elements can be dispensed with as a result of the at least one flow control element arranged particularly in addition to a supply device and which is preferably integrated in the hydrodynamic device but can also be integrated in its entirety or partially in a downstream transmission. A further advantage consists in that flexibility is increased because an active control of, and alternatively or additionally a passive control of, the flow control element is made possible via the difference in speed between the impeller wheel and turbine wheel. This allows a corresponding control in a flexible manner as a function of the speed.

In the following, “shaft” does not refer exclusively to, for example, a cylindrical rotatably mounted machine element for transmitting torque, but rather also to connection elements in generals which connect individual components or elements to one another, in particular connection elements which connect a plurality of elements to one another so as to be fixed with respect to relative twisting.

Two elements are referred to particularly as being connected to one another when a fixed connection, particularly a connection fixed with respect to relative twisting, exists between the elements. In particular, connected elements of this kind rotate at the same speed.

Two elements are referred to hereinafter as couplable or connectible when a detachable connection exists between these elements. In particular, elements of this kind rotate at the same speed when the connection exists.

The various component parts and elements of the present invention can be connected to one another via a shaft or a connection element, but also directly, for example, by a weld connections press connection or other type of connection.

Preferably, in the description and particularly in the claims, “clutch” denotes a switching element that, depending on actuation state, permits a relative movement between two component parts or a connection for transmitting torque. By “relative movement” is meant for example, a rotation of two component parts, where the speed of the first component part diverges from the speed of the second component part. Further, it is also conceivable that only one of the two component parts rotates while the other component part is stationary or rotates in opposite direction.

A non-actuated clutch means hereinafter an open clutch. This means that a relative movement is possible between the two component parts. When the clutch is actuated or closed, the two component parts accordingly rotate at the same speed in the same direction.

The flow control element is advisably constructed in such a way and/or can be actuated in such a way that a large liquid flow can be supplied to the hydrodynamic device at a first differential speed and a small liquid flow can be supplied to the hydrodynamic device at a second differential speed, where the first differential speed is higher than the second differential speed. Accordingly, during high power loss, i.e., at a high differential speed, a high liquid flow can be supplied to the torque converter device and with decreasing power loss a smaller liquid flow can be supplied to the torque converter device.

The at least one flow control element can advantageously be actuated by a translational and/or rotational movement of one or more actuating elements of the hydrodynamic device. Accordingly, the flow control element can be actuated in a simple and economical manner by the hydrodynamic devise depending on a speed difference between elements thereof.

At least one of the actuating elements is advisably constructed as a stator wheel support for the stator wheel such that the stator wheel support is twistable at least partially relative to the housing arrangement, and that the at least one flow control element can be actuated depending on the twist angle of the stator wheel support relative to the housing arrangement. The stator wheel support is accordingly mounted in the transmission housing so as to be twistable over a determined angle. The twisting can be adjusted, for example, via mechanical stops via a force equilibrium so as to ensure that the torque is supported. In this way, overall, a simple and economical actuation of the at least one flow control element can be provided for the control of the liquid flow based on the speed difference.

In an advantageous manner, the at least one flow control element is configured to provide a variable cross section and/or a variable length for a throughflow of the liquid. In this way, the flow for the inlet and/or outlet of the circuit, for example, and in lines of the circuit can be controlled in a simple manner. All possible switching states are conceivable in this respect; for example, a complete closure of lines or change in the flow direction in the converter without influencing the external hydraulic control. A temperature-dependent control of the liquid flow can also be realized if the flow control element also provides in addition to a change in cross section a certain length of a line which is provided with the cross section, i.e., acts as choke. When the cross section and the length of the effective cross section are changed, throughflow can be at least partially prevented, for example, during a cold start of a vehicle when the coolant oil is not yet heated and is therefore viscous, through a suitable choke configuration so that the torque converter can heat up faster. A variable length can be carried out, for example, through a “telescopic” extension of a plurality of hollow shafts arranged one inside the other, or the like.

The at least one flow control element is advisably constructed as a slide element, a diaphragm element and/or a blocking element. A simple and economical construction of the flow control element is ensured in this way.

The slide element is advantageously disk-shaped, spherical, conical and/or cylindrical. This ensures an economical production on the one hand, and the slide element can be constructed correspondingly depending on requirements on the other hand.

At least one preloading element is advisably arranged for the at least one flow control element and/or for the at least one actuating element such that the flow control element can be arranged in a defined initial position. This makes it possible to achieve a position-dependent torque equilibrium so that, for example, a line cross section is released, closed or changed depending on the torque load, for example, the flow control element can be configured via meaningful arrangement of channels of the circuit such that the flow control element allows different or variable cross sections or different guiding of the hydraulic liquid in the circuit depending on the supporting torque. At a given pressure gradient, for example, a variable volume flow through the torque converter device can be generated. For example, when the supporting torque of the stator wheel support is utilized, the supporting torque decreases as the differential speed decreases and therefore also the conversion of torque. Accordingly, the position-dependent torque equilibrium can be achieved through the preloading element.

The at least one preloading element can advantageously be actively and/or passively actuated mechanically, hydraulically and/or electrically. In this way, the preloading element can be flexibly adapted to external circumstances or actuated by passive and/or active actuators in a simple and economical manner. Further, an advantage consists in that the actuators are actuated to make possible certain cooling strategies for the torque converter. Alternatively or additionally, an influencing element that changes the tension characteristic of the preloading element, for example, the stiffness of a spring, can be arranged for the preloading element. This makes it possible to change the passive switching speed of the flow control element so that, for example, after-cooling can also be made possible above the switching point by delaying a resetting of the preloading element, for example, in the form of a spring.

A resetting device and/or a retaining device are/is advisably arranged for the flow control element. The retaining element ensures that the flow control element is always in a defined position. If the flow control element is actuated through a deflection, for example, the resetting device for the flow control element and/or for an actuating element for the flow control element allows the position of the respective element to be reset in every instance.

The resetting device and/or retaining device advantageously comprise one or more elastic elements, particularly in the form of helical springs, leaf springs and/or torsion springs. A retaining device and/or a resetting device can be made available economically in this way.

The retaining device is advisably constructed in the form of at least one catch device, and in particular the catch device is configured in a direction-dependent manner. This substantially increases flexibility during use of the torque converter device. For example, this can make it possible to lock the flow control element and/or actuating element in any position with corresponding dependence on support torque, for example, of the stator wheel support. The retaining device can be arranged together with the resetting device in such a way that a change in the effective resetting force is generated along a rotating angle so as to allow a defined delay or hysteresis of the flow control element between a rise in the supporting torque of the stator wheel support and a corresponding drop. A delay of this kind is advantageous after a high power input which causes a greater flow; this ensures a sufficient after-cooling. Beyond this, it is also possible to directly switch the liquid flow to a maximum liquid flow after a determined limit load is exceeded, where different angular positions of the flow control element and/or of the actuating element can be continuously variable at reduced load. A catch device can be made possible, for example, in the form of a ball detent and can have different or asymmetrically arranged ramps or ramps which narrow in diameter with different angles for direction-dependent actuation or also through a pin engaging in a channel, or the like.

In an advantageous manner, external inlets and/or outlets are arranged for the circuit and the liquid flow can be entirely or partially diverted into these external inlets and/or outlets by the at least one flow control element. One of the advantages achieved in this way consists in that elements arranged outside the circuit can also be actuated as required depending on the speed difference. For example, in this way the liquid flow can flow into the downstream transmission to lubricate the gear set or into other required areas so as to allow a weaker or smaller pump to be used for this purpose. The reason for this is that the demand for lubrication of the gear set is generally reciprocally proportional to the demand for cooling the torque converter so that an alternating and/or at least partially shared utilization of the liquid flow is possible.

A damping element for damping the movement of the flow control element and/or of the actuating element is advantageously arranged. An impacting of the stator wheel support during the corresponding deflection or resetting to the initial position can be prevented or at feast reduced in this way. The damping element can be constructed in the form of a rubber buffer or the like, for example.

The flow control element is advantageously configured to control the liquid flow in radial and/or axial flow direction. In this way, the flow control element can be correspondingly adapted to a wide variety of circumstances in the transmission, which increases flexibility with respect to the configuration of the torque converter device.

Advisably, the retaining device is constructed so as to be temperature-dependent and in particular comprises a bimetal and/or a memory metal. In this way, the retaining device can be made temperature-dependent in a simple manner. For example, the retaining device can cooperate with the flow control element and/or the actuating element such that when the temperature falls below a certain temperature level this allows the flow control element to provide a maximum throughflow until the temperature again drops below a certain temperature level. A sufficient after-cooling can be ensured in this way. The retaining device can be constructed, for example. In the form of a bimetallic switch or memory metal switch and as an active catch mechanism that holds the flow control element in its open position after being opened until a control signal, for example, releases the catch mechanism again.

The actuating element and the flow control element are advantageously formed in one piece. This enables a simple and economical production on the one hand and a reliable actuation of the flow control element on the other hand.

Further important features and advantages of the invention are indicated in the subclaims, drawings and from the accompanying description of the drawings.

It will be appreciated that the features mentioned above and those which will be described hereinafter may be used not only in the combinations indicated herein but also in other combinations or individually without departing from the scope of the present invention.

### BRIEF DESCRIPTION OF THE DRAWINGS

Preferred embodiments and embodiment forms of the invention are shown in the drawings and are described more fully in the following description. Identical reference characters denote identical or similar or functionally identical component parts or elements.

Shown schematically:

FIGS. 1a-d are cross sections and longitudinal sections through a portion of a torque converter device;

FIG. 2 is an axial section through a portion of a torque converter device;

FIG. 3 is a cross section through a portion of a torque converter device;

FIG. 4 is an axial section through a portion of a torque converter device;

FIG. 5 is an axial section through a portion of a torque converter device;

FIG. 6 is an axial section through a portion of a torque converter device;

FIG. 7 is a cross section through a portion of a torque converter device;

FIG. 8 is a cross section through a portion of a torque converter device;

FIG. 9 is a cross section through a portion of a torque converter device;

FIG. 10 is an axial top view of a portion of a torque converter device;

FIG. 11 is an axial top view of a portion of a torque converter device;

FIG. 12 is an axial top view of a portion of a torque converter device;

FIG. 13 is a catch device for a torque converter device;

FIG. 14 is a characteristic map for a diaphragm cross section over pressure differential and volume flow for a flow control element in the form of a supporting shaft slide based on a diaphragm for a torque converter device;

FIG. 15 is a characteristic map for a stator wheel supporting torque over a speed ratio and a pump speed for a torque converter device.

FIG. 16 is a switching characteristic map for a stator wheel supporting shaft slide with a switching threshold and maximum limit for a torque converter device;

FIG. 17 is a switching characteristic map for a stator wheel supporting shaft slide with switching threshold and maximum limit for a torque converter device;

FIGS. 18a-e are diagrams showing the relationship between twist angle, restoring force and stator wheel supporting torque of a linear spring and a top dead center spring;

FIGS. 19a-b is a cross section and axial section and angled surface of a hollow shaft with variable cross section for a torque converter device;

FIG. 20 is a cross section and axial section and angled surface of the hollow shaft with variable cross section for a torque converter device according to FIG. 19 which is twisted relative to a hub;

FIG. 21 is a cross section through a portion of a torque converter device; and

FIG. 22 is an angled surface for a portion of the torque converter device.

### DETAILED DESCRIPTION OF THE PRESENTLY PREFERRED EMBODIMENTS

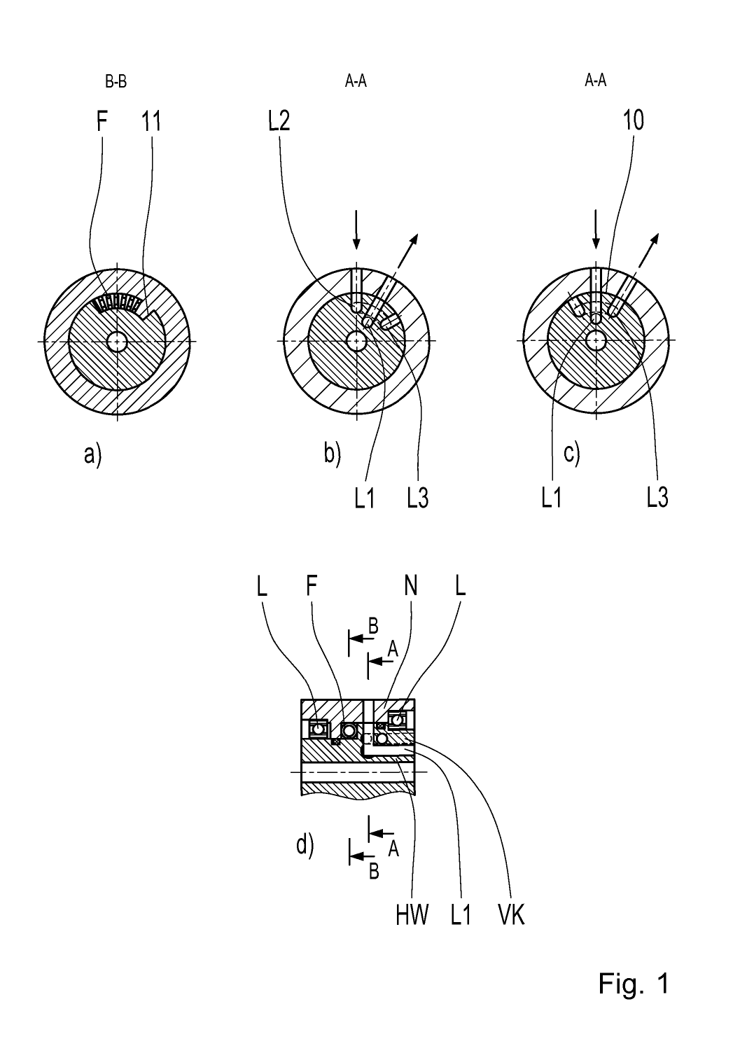

FIGS. 1a-d show cross sections and longitudinal sections, respectively, through a portion of a torque converter device according to a first embodiment form of the present invention.

FIGS. 1a-d show three lines L1, L2, L3 arranged in a hollow shaft HW. The hollow shaft HW is supported so as to be twistable in a hub N that has only one feed line and a discharge line. The hub N and the hollow shaft HW are held in the position shown in FIG. 1c by a spring F shown in unloaded state in FIG. 1a, Line L1 is oriented to the feed line and line L3 is oriented to the discharge line. Line L2 is not used in the present case. When the hollow shaft HW undergoes a torque, the spring F is compressed according to FIG. 1b so that line L1 is now connected to the discharge line and line L2 is now connected to the feed line. Line 3 is not used in this case. Line L2 and line L3 are connected via a connection channel VK so that there is always flow through all of the lines. In order to prevent or reduce impacts of the hub against the hollow shaft HW when spring F relaxes, a damping element 11, for example, in the form of a rubber buffer, can be arranged therebetween. The gap/sealing gap between hollow shaft HW and hub N is made to be small enough that flow losses between the feed line and discharge line are as low as possible. An additional sealing element 10 can be arranged in this case, for example. Accordingly, the transition between hub N and hollow shaft HW serves as control edge ST for the flow between lines L1 and L3.

This construction can also be carried out at the transition of a stator wheel supporting shaft to the transmission housing in that the hollow shaft is replaced by the stator wheel supporting shaft and the hub is replaced by the transmission housing and/or at or in the stator wheel/freewheel. The hollow shaft is then replaced by the free space inner ring and the hub is replaced by the freewheel outer ring.

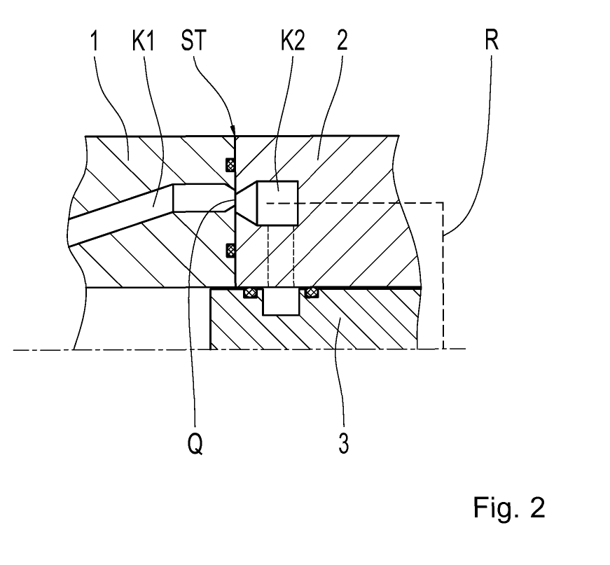

FIG. 2 shows an axial section through a portion of the torque converter device according to a second embodiment form of the present invention.

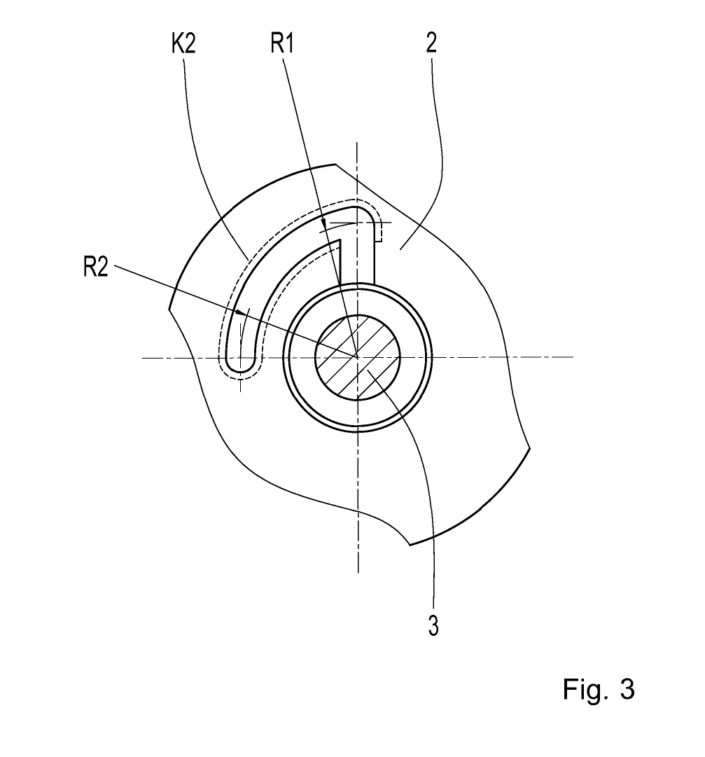

FIG. 2 shows a sectional view of an axial control edge ST with variable cross section. The component part 2 on the right-hand side is fixed with respect to the transmission and has a tangentially extending channel K2 which has sufficiently large dimensions and which communicates with the bore hole K1 provided in the component part 1 on the left-hand side. The cross-sectional area Q for the flow between channels K1, K2 can be varied via the angular position through a continuously changing radius R1, R2 of the channel K2 of component part 2 as is shown in FIG. 3. Also shown is a rotary feed represented by the shaft 3 that is optional. A direct, dense supply is possible via a transmission interface owing to the fact that component part 2 is connected so as to be fixed with respect to the transmission. A choke configuration is also possible so that a temperature dependence of cross section Q and, therefore, of the flow quantity can be achieved.

FIG. 3 shows a cross section through a portion of a torque converter device according to a third embodiment form of the present invention.

FIG. 3 shows the cross section of the component part 2 according to FIG. 2. The tangentially running feed channel K2 extending substantially over a quarter-circle and haying varying radius R1, R2 along the circumference of the quarter-circle can be seen. Accordingly, the cross-sectional area Q can change depending on the rotational angle of component part 1 for the hydraulic liquid.

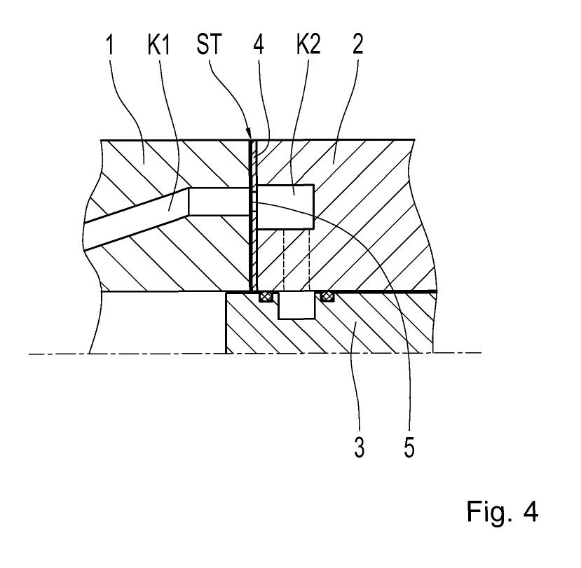

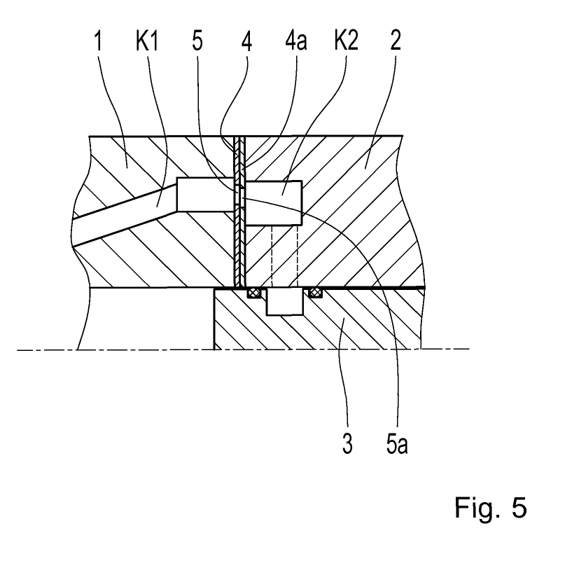

FIG. 4 shows an axial section through a portion of a torque converter device according to a fourth embodiment form of the present invention.

FIG. 4 shows substantially the same construction as that in FIG. 2. FIG. 4 differs from FIG. 2 in that there is arranged between component part 1 and component part 2 a thin diaphragm disk or diagram ring 4 which provides angular-position-dependent cross sections for a passage 5 and allows changes to the throughflow resistance as a function of the twist angle.

FIG. 5 shows an axial section through a portion of a torque converter device according to a fifth embodiment form of the present invention.

FIG. 5 shows substantially the same construction as in FIG. 4. The difference from the construction according to FIG. 4 is that in the construction according to FIG. 5 a change in the diaphragm cross section is made between the two component parts 1 and 2 by two diaphragm rings 4, 4a, which makes possible the angular-position-dependent cross sections 5, 5a.

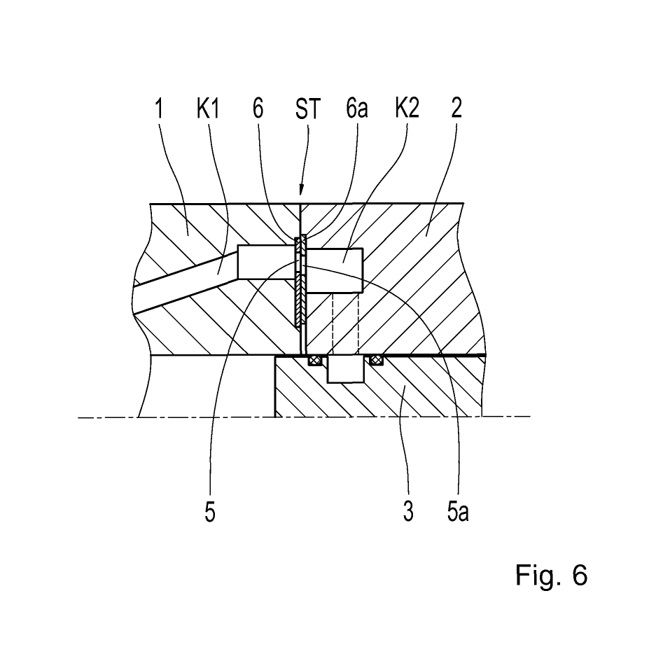

FIG. 6 shows an axial section through a portion of a torque converter device according to a sixth embodiment form of the present invention.

FIG. 6 shows substantially the same construction as the construction shown in FIG. 5. In contrast to the construction according to FIG. 5, the diaphragm segments 6, 6a are not arranged in the form of rings that extend along the entire radial extension of the two component parts 1 and 2, but rather the corresponding diaphragm segments 6, 6a are arranged in corresponding depressions in the respective component parts 1 and 2. Accordingly, a corresponding depression is provided in component part 1 for diaphragm segment 6 which has a passage 5 and a corresponding depression for receiving the diaphragm segment 6a with passage 5a is arranged in component part 2.

The cross sections of the diaphragm or diaphragm segments shown in FIGS. 4 to 6 has in particular a steadily rising or falling cross-sectional area, preferably between 4 mm² and 10 mm².

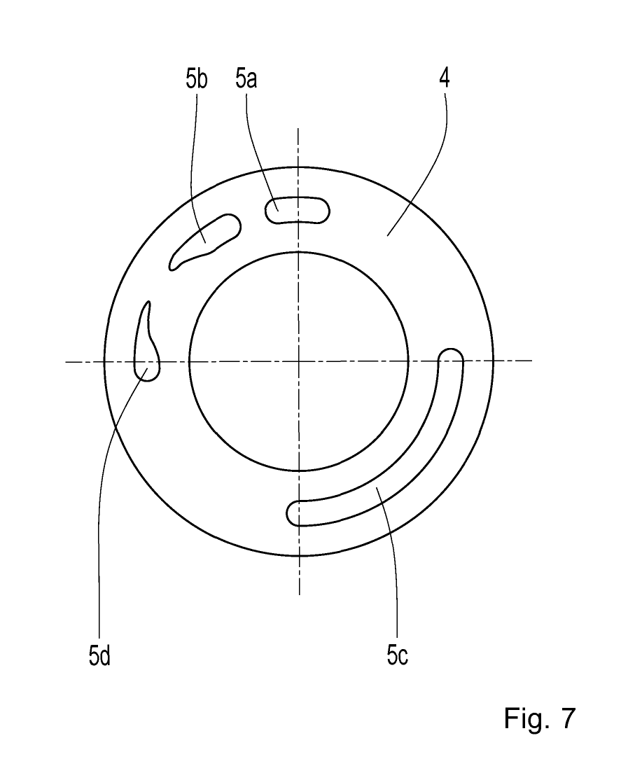

FIG. 7 shows a cross section through a portion of a torque converter device according to a seventh embodiment form of the present invention.

FIG. 7 shows an axial top view of a diaphragm ring 4 having differently shaped orifices 5a, 5b, 5c and 5d which can be adapted depending on application or circumstances. These orifices can be drop-shaped, oval, symmetrical and/or asymmetrical in circumferential direction in their entirety or partially. The orifices in FIG. 7 extend substantially in the upper left-hand area and lower right-hand area of the diaphragm ring 4. The lower orifice 5c serves as a return or outflow and by reason of its configuration ensures that the outflow is always open during twisting of the diaphragm ring 4. Using the upper or left-hand orifices 5a, 5b, 5c, certain states can be realized for the liquid flow to the torque converter. Of course, in the present instance and also generally the inflow and outflow can be exchanged.

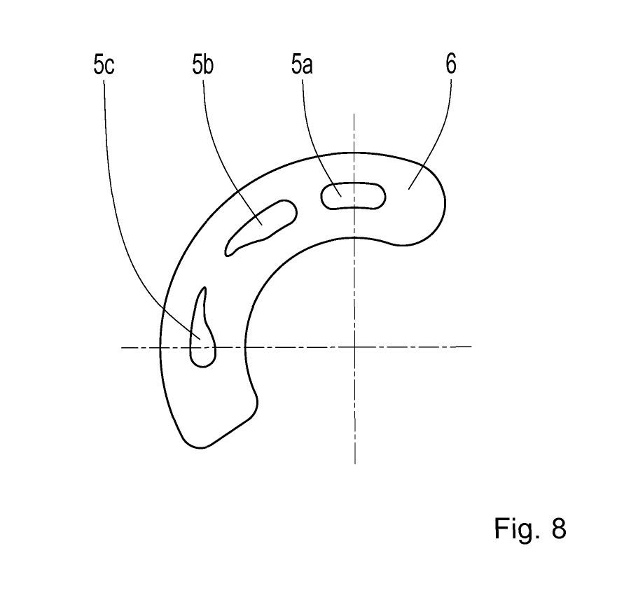

FIG. 8 shows a cross section through a portion of a torque converter device according to an eighth embodiment form of the present invention.

FIG. 8 shows a substantially quarter-circle-shaped diaphragm segment 6 which has different cross sections or orifices 5a, 5b, 5c and can be adapted depending upon external circumstances or application. They can be constructed in the manner described above.

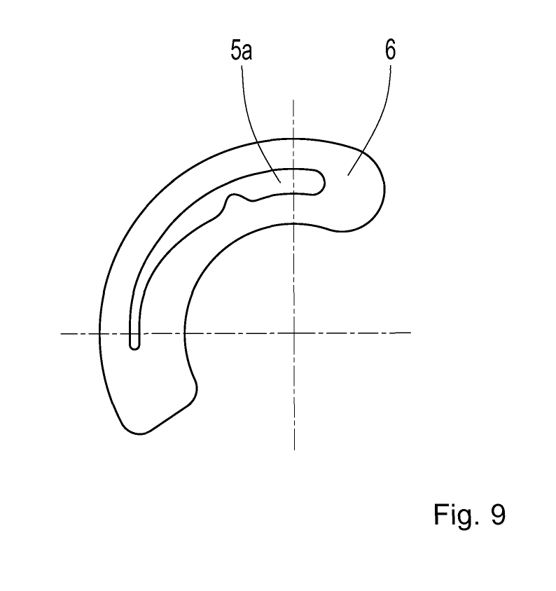

FIG. 9 shows a cross section through a portion of a torque converter device according to a ninth embodiment form of the present invention.

FIG. 9 shows a further embodiment form of a diaphragm segment 6 with a variable cross section 5a. The cross section narrows considerably in diameter in one area and otherwise decreases or increases continuously in circumferential direction.

In particular, FIGS. 8 and 9 show diaphragm segments 6 which serve to change the cross section of a line. Of course, a further diaphragm segment can be arranged for a further line.

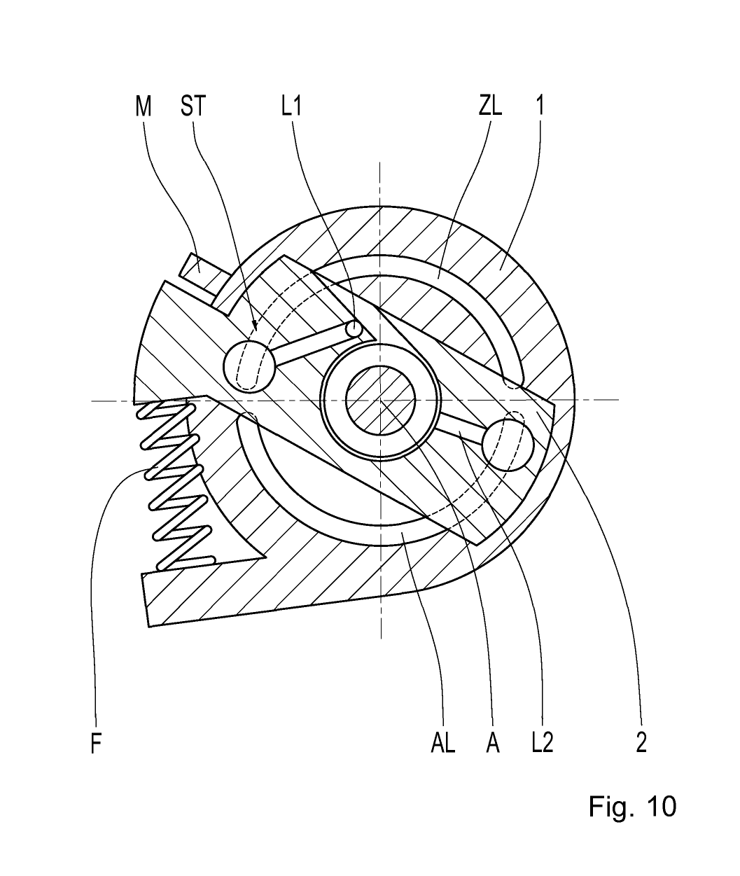

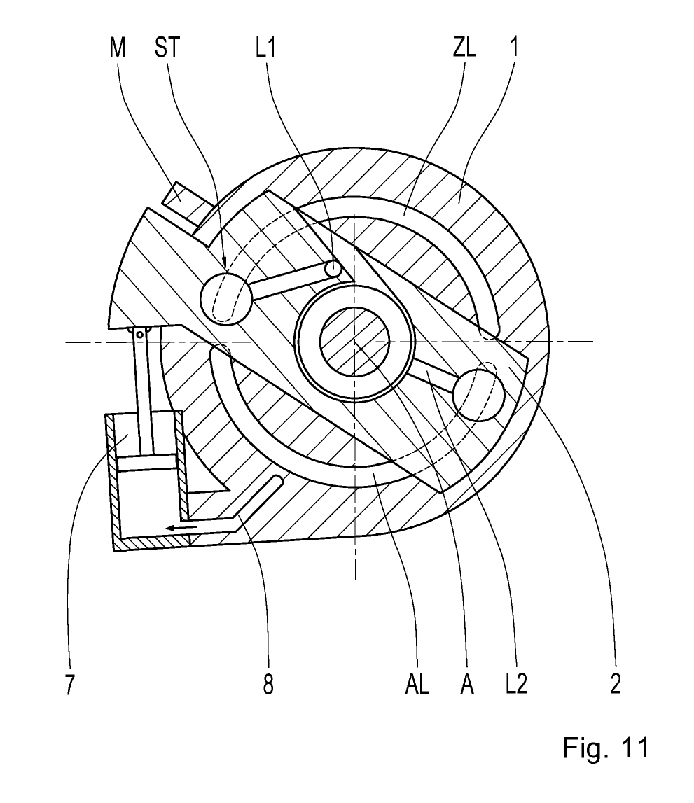

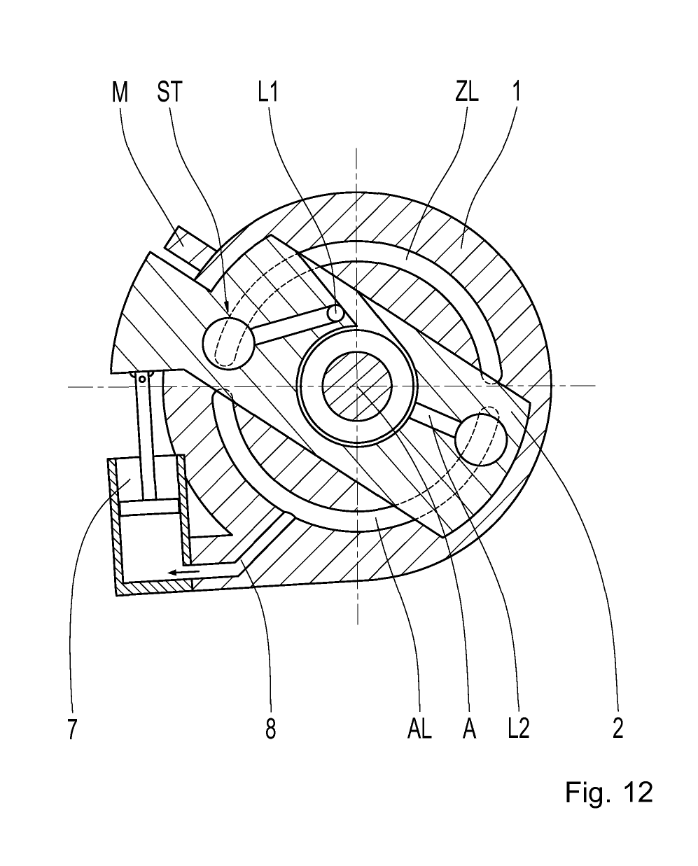

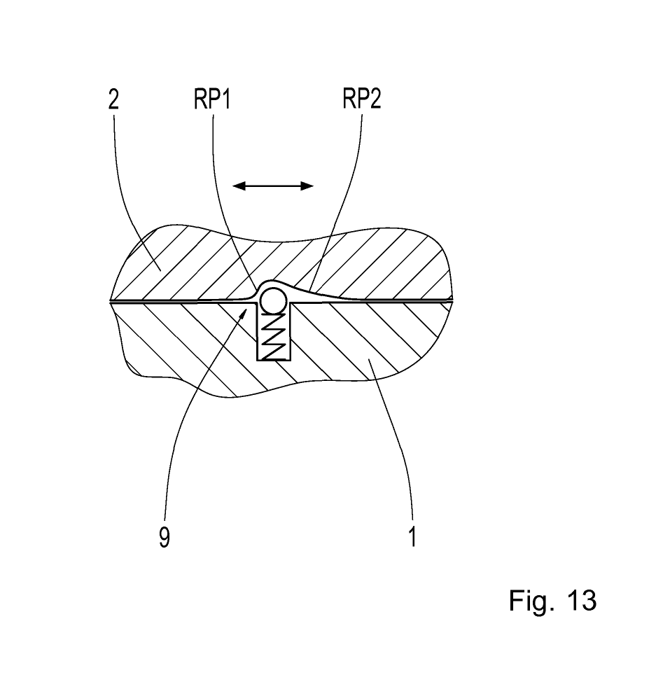

FIG. 10 shows an axial top view of a portion of a torque converter device according to a tenth embodiment form of the present invention. FIG. 11 shows an axial top view of a portion of a torque converter device according to an eleventh embodiment form of the present invention. FIG. 12 shows an axial top view of a portion of a torque converter device according to a twelfth embodiment form of the present invention. FIG. 13 shows a catch device for a torque converter device according to a thirteenth embodiment form of the present invention.

FIGS. 10-12 show, respectively, an axial top view of a switching device for the flow direction of a coolant oil flow or hydraulic liquid flow shown in an initial position for the operating range in which the converter clutch of a torque converter device is closed and for converter operation with small differential speeds. For the sake of simplicity in the drawing, no diaphragms or diaphragm segments 6 or lines L1, L2, L3, ZL, AL having specific or variable cross sections are shown in FIGS. 10-12. Of course, the latter can be arranged.

In FIGS. 10-12, line L1 leads to the converter, line L2 leads to the outlet AL and inlet ZL such ax also arranged in component part 2 in FIG. 2, for example. If component part 2 is twisted or rotated in clockwise direction relative to component part 1, line L1 is connected to outlet AL at control edge ST and line L2 is connected to inlet ZL so that the flow direction is reversed counter to the initial position which is shown in FIGS. 10-12 and in which line L1 is connected to inlet ZL and line L2 is connected to outlet AL.

A restoring device F in the form of a spring is arranged in FIG. 10 and a restoring device in the form of a hydraulic actuator is arranged in FIG. 11, the latter being controlled via an external feed line 8 in FIG. 11 and can be controlled in FIG. 12 via the return action of a pressure, for example, in the outlet line AL, through a direct connection of the hydraulic actuator to the outlet AL by line 8. Further, a mechanical stop M, which limits the rotational angle of component part 2 relative to component part 1, is arranged in FIGS. 10 to 12. Of course, a second mechanical stop, which limits the twist angle of component part 2 in the clockwise direction as well as in counterclockwise direction, can also be provided. However, a limiting of this type is also possible, for example, via a pin engaging in a corresponding channel.

Besides this, a limiting of this kind is also possible by arresting such as is shown in FIG. 13 in the form of a ball detent. This can be arranged not only as a limiting of the exclusive end position or of the twist angle, but rather an arresting can also be carried out at any angular position with corresponding dependencies of the respective torque on component parts 1, 2 or on the stator wheel support of a hydrodynamic device. A restoring spring arrangement that generates a change in the effective restoring force via the rotational angle is also possible so that a defined delay or hysteresis of a diaphragm such as that shown in FIG. 4, for example, is made possible between an increase in supporting torque and decrease in supporting torque of a stator wheel support. This is especially advisable if e.g., after a high input of power, a larger throughflow or an after-cooling must be ensured. Beyond this, this may also be advisable in order to directly switch the hydraulic liquid flow to a maximum hydraulic liquid flow after a determined threshold load has been exceeded, and the rotational angle position can also be configured so as to be continuously variable under smaller load.

Further, a direction-dependent arresting is also possible so that position or hysteresis via force or torque is dependent upon the movement direction. In the case of a direction-dependent arresting, there is an equilibrium of force between supporting torque, restoring force of the spring or actuator and the force for the arresting. This also makes fast switching possible: a cooling of the torque converter device is carried out up to determined supporting torques in the initial position. Subsequently, a fast switching to a target operating position is made possible and an optimal cooling is ensured. Through different diaphragm stages, control vibrations of the hydraulic liquid, for example, can also be prevented or a stall operation, i.e., for example, in a transmission, the drive rotates while the output is stationary, can also be intercepted in that the liquid flow is intercepted, i.e., is not further increased, at a certain level. A direction-dependent arresting can be achieved, for example, via differently formed ramps RP1, RP2 for the depression in which a detent engages. In FIG. 13, this is achieved essentially through different slopes of the ramps RP1, RP2 along the relative movement direction between the two component parts 1, 2.

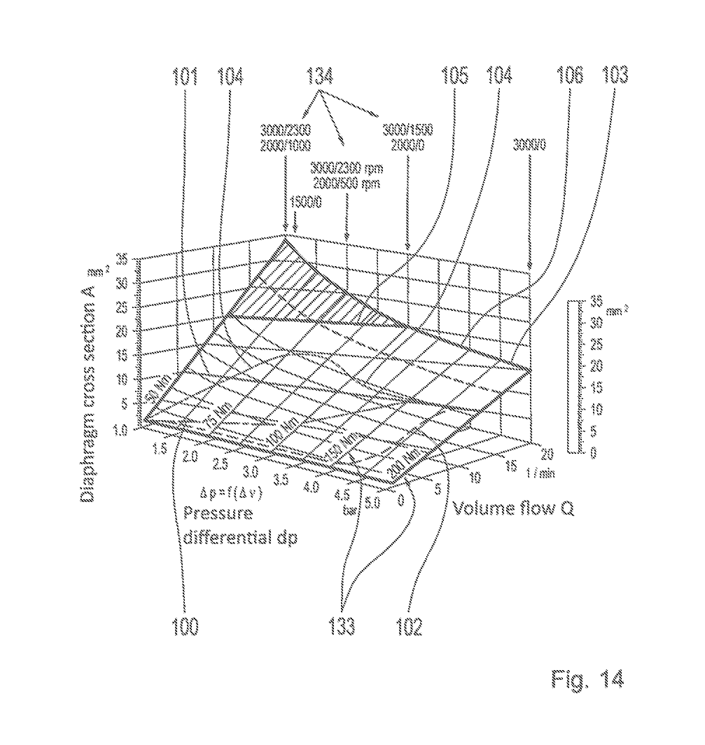

The following operating ranges are particularly relevant for the torque converter according to the subsequent FIGS. 14 to 18:

1. A so-called “normal position”—first operating range—in which the stator wheel is in the initial position and the stator wheel supporting torque rises until a switching threshold.

2. The second range is the so-called control range in which a switching threshold 130 is exceeded, and the stator wheel is angularly twisted, and the angle depends on the stator wheel supporting torque above the control range threshold 130.

3. The third operating range is characterized by the maximum limit position, i.e., the arresting threshold and control range threshold 130 is exceeded, the stator wheel is twisted by the maximum angle and is in its maximum angular position, i.e., the deflecting angle is at the maximum. The stator wheel is located in the maximum angular position through switching or top dead center TDC position with reduced restoring force. The maximum position is accordingly retained longer until the supporting torque falls below the restoring force in the end position.

FIG. 14 shows a characteristic map for a diaphragm cross section over pressure differential and volume flow for a flow control element in the form of a supporting shaft slide based on a diaphragm for a torque converter device according to a fifteenth embodiment force of the present invention.

FIG. 14 shows a possible configuration for a diaphragm cross section depending on the diaphragm pressure differential and depending on the corresponding volume flow of a hydraulic liquid. Certain stator wheel supporting torques 133 which correlate with the differential speed between the pump and turbine 134 are shown representatively in the drawing. Curves 100 to 104 show possible curves of a diaphragm configuration by way of example that must still be converted to a corresponding twist angle for the diaphragm. Further, two limits 105 and 106 are shown. Reference numeral 105 represents the limit of the diaphragm cross section and limit 106 represents the limit of an external volume flow for the hydraulic liquid. The limits 105 and 106 are to be considered under the assumption of maximum diaphragm diameter and maximum possible volume flow. For example, FIG. 14 shows that at a low supporting torque 133 a smaller volume flow is available and that the volume flow 107 corresponding to the constant diaphragm rises with increasing supporting torque 133. When the latter reaches the volume flow limit 106, then with respect to hydraulics, volume flow is no longer available for the hydraulic liquid, which would lead to a pressure drop in the feed line. This can be prevented by a corresponding reduction in the diaphragm cross section.

In detail, curve 100 exhibits a stepped increasing characteristic that initially rises linearly up to a stator wheel support point of 100 Nm, then rises more sharply until a stator wheel supporting torque of 150 Nm and then runs flat again until the maximum stator wheel supporting torque of 200 Nm. Curve 101 shows the corresponding characteristic line for a diaphragm with constant cross section. Curve 102 shows the characteristic line for a constant volume flow up to 150 Nm stator wheel supporting torque with a slightly S-shaped contour between 150 Nm and 200 Nm stator wheel supporting torque, i.e., with pronounced progressivity at maximum output such as would be required, for example, for a stall operation. Curve 103 shows the line of a constant volume flow Q, and curve 104 shows an individually adjusted characteristic defined by a given application.

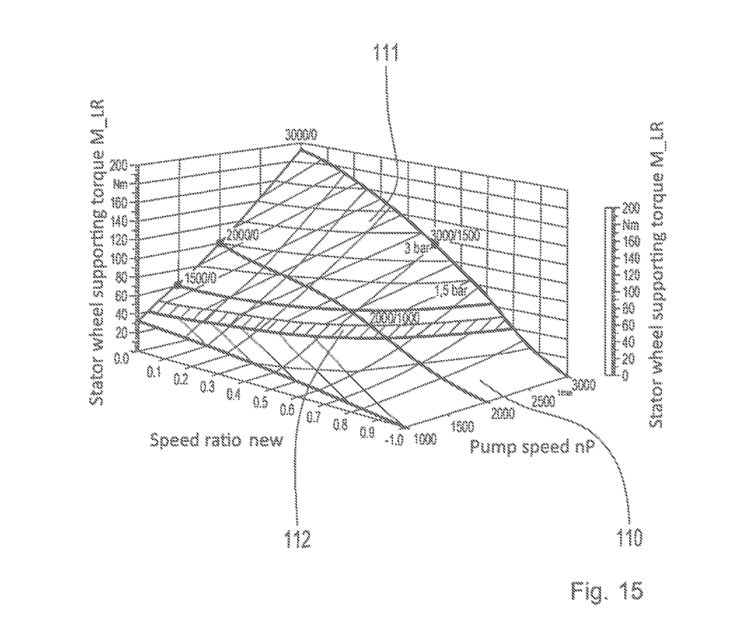

FIG. 15 shows a characteristic map for a stator wheel supporting torque over a speed ratio and a pump speed for a torque converter device according to a fifteenth embodiment form of the present invention.

FIG. 15 shows the stator wheel supporting torque plotted over the speed ratio and the input speed/pump speed. Combined with FIG. 14, it allows the respective rotational angle to be determined. Various operating ranges are shown. In range 110, the flow control element is in its “normal” position, i.e., is not switched. In range 111, the flow control element is in the “control”position (control range), i.e., is switched. There is a switching range 112 between the two ranges 110 and 111, i.e., a switching point with hysteresis.

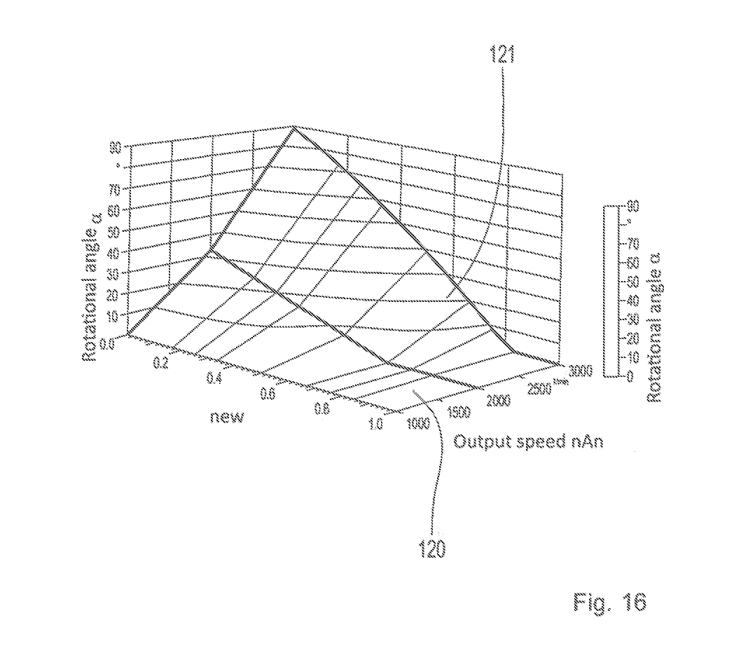

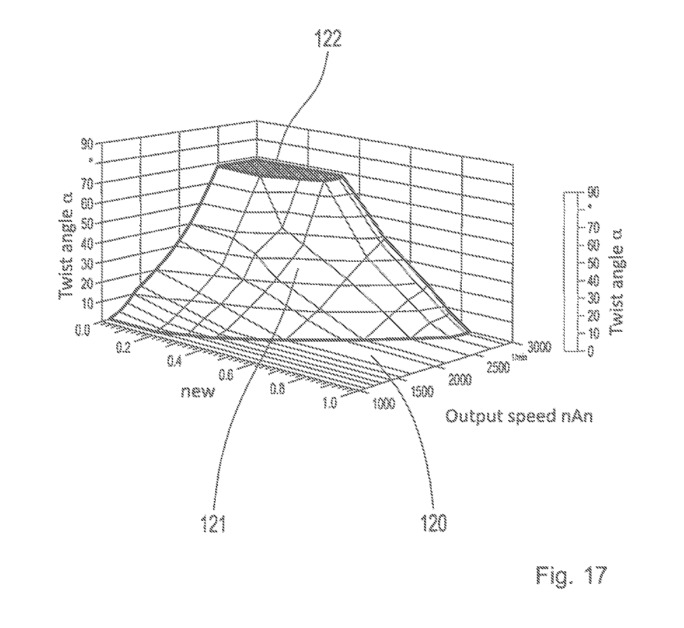

FIG. 16 shows a switching characteristic map the a stator wheel supporting shaft slide with switching threshold and maximum limiting for a torque converter device according to a sixteenth embodiment form of the present invention, and FIG. 17 shows a switching characteristic map for a stator wheel supporting shaft slide with switching threshold and maximum limiting for a torque converter device according to a seventeenth embodiment form of the present invention.

FIGS. 16 and 17 show the twist angle over the speed ratio and input speed. They are determined on the basis of a linear restoring force curve. The switching characteristic map is divided into two fields in FIG. 16. In field 120, the respective flow control element, in the present case in the form of a slide, is not switched, and in field 121 the flow control element is switched and the twist angle of the flow control element is carried out as a function of the speed difference. Further, the maximum twist angle is limited to approximately 68° in FIG. 17, which is shown by field 122. FIG. 17 accordingly shows a switching threshold with additional end stop (reference numeral 122).

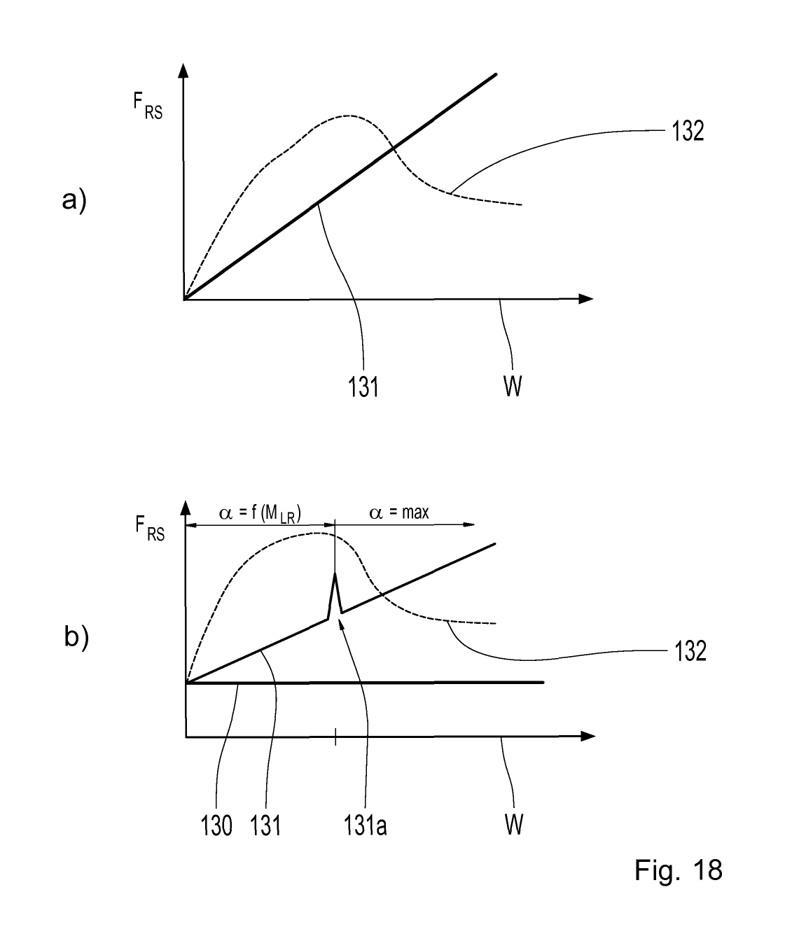

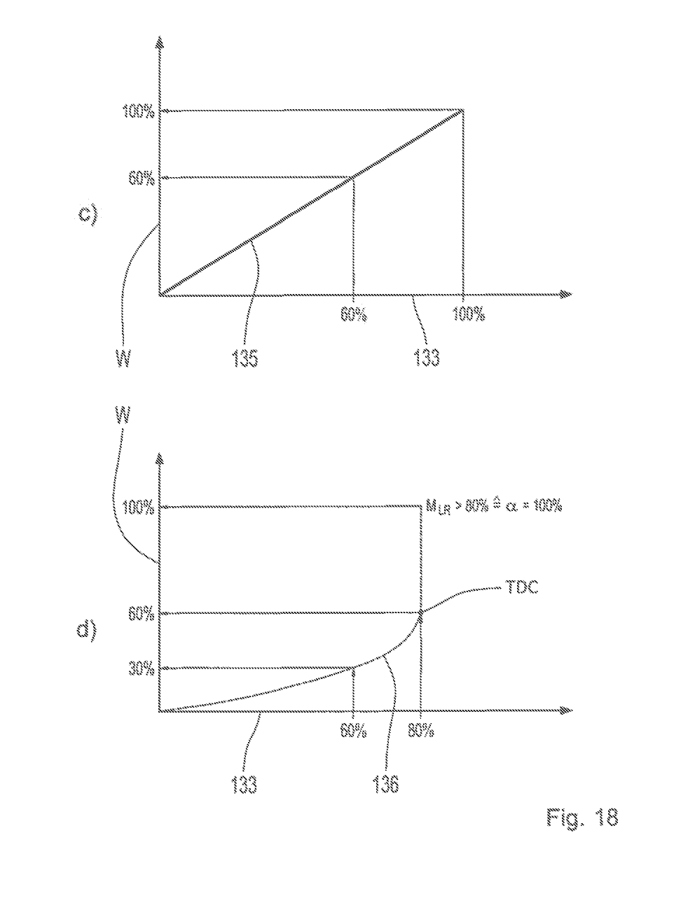

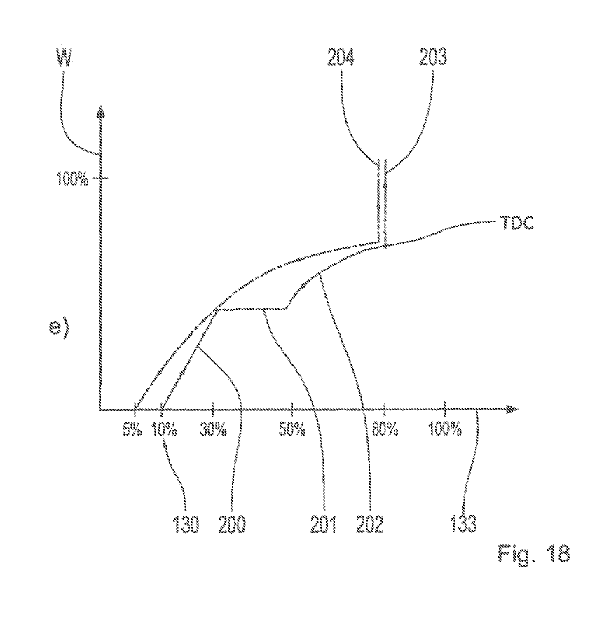

FIGS. 18a-e show diagrams for the relationship between twist angle, restoring force and stator wheel supporting torque of a linear spring and a top dead center spring.

FIGS. 18a-b show the restoring force over the twist angle W. In FIG. 18a, the restoring force takes place linearly (curve 131) relative to the twist angle W. A curve 132 for the restoring force as a function of the angle for a top dead center spring (TDC spring) having a reduced restoring force in a top dead center position is shown in dotted lines. In FIG. 18b, an additional threshold is shown for the control range 130. Accordingly, the flow control element is not actuated at ad until the threshold 130 of the restoring force is exceeded. Further, a triangular rise in restoring force proceeding from the linear curve 131a which is caused by an arresting of the flow control element and its twist angle W is also shown. When the arresting takes place, a higher restoring force must be applied in order to cancel the arresting again.

In FIGS. 18c-d, the twist angle W is plotted over the stator wheel supporting torque 133 for a linear restoring force (FIG. 18c) and for a nonlinear restoring force (FIG. 18d) which is provided by a top dead center spring. In case of a linear restoring force, the twist angle W is proportional (curve 135) to the stator wheel supporting torque 133, i.e., at a value of 60% of the maximum stator wheel supporting torque 133, the twist angle W likewise has a value of 60% of the maximum twist angle W (FIG. 18c). The twist angle W during the nonlinear restoring force provided by the top dead center spring takes place non-linearly as a function of the stator wheel supporting torque 133. At 60% of the maximum supporting torque 133, which can be provided by the stator wheel the twist angle W likewise only has a value of 30% of the maximum twist angle W. At top dead center TDC, which is reached in FIG. 18d at 80% of the maximum stator wheel supporting torque 133 corresponding to a twist angle value W of 50% of the maximum twist angle W, a deflection takes place directly to the maximum value of the twist angle W, since the top dead center spring makes less restoring force available at and after top dead center TDC during further deflection than for compensation of the further deflection of the stator wheel support through the stator wheel supporting torque 133 (curve 136 and top dead center TDC in FIG. 18d).

In FIG. 18e, the twist angle W is plotted as a function of the stator wheel supporting torque 133. In this regard, a threshold 130 for the control range is assumed at 10% of the maximum value of the stator wheel supporting torque 133, i.e., at stator wheel supporting torques 133 below that there is no controlling of the throughflow through the flow control element. When the control threshold 130 of 10% of the maximum value of the stator wheel supporting torque 133 is exceeded, the twist angle W initially follows the rising stator wheel supporting torque 133 substantially linearly. After a stator wheel supporting torque 133 of 30% of the maximum value of the stator wheel supporting torque 133, an arresting (range 201) takes effect, i.e., the stator wheel supporting torque 133 rises without a further increase in the twist angle W because of the arresting. The curve shown in FIG. 18e accordingly runs horizontally in range 201 which extends between 30% and 50% of the maximum value of the stator wheel supporting torque 133. If the stator wheel supporting torque 133 increases further over 50% of the maximum value of the stator wheel supporting torque, the twist angle W rises again further nonlinearly until a top dead center TDC which is reached at 80% of the maximum value of the stator wheel supporting torque 133. If the stator wheel supporting torque 133 exceeds this value, the maximum possible twist angle W is directly adjusted (range 203). The portions described above are referred to as switch-on characteristic, i.e., ranges 200-203 are run through when the stator wheel supporting torque increases.

Conversely, curve 204, which represents an example of a switch-off characteristic, is run through during a reduction of the stator wheel supporting torque. When the stator wheel supporting torque 133 is at the maximum possible value, the maximum value of the twist angle W is first reduced when felling below the top dead center TDC, i.e., the stator wheel supporting torque 133 has fallen below 80% of the maximum value of the stator wheel supporting torque 133. Arresting no longer takes place because the arresting is formed in a direction-dependent manner and takes effect only during a rise in the stator wheel supporting torque 133. Further, curve 204 does not correspond exactly to the curve of portions 200 and 202, but rather has a certain hysteresis. At 5% of the maximum value of the stator wheel supporting torque 133, there is no longer an angle deflection W. Because of the rising stator wheel supporting torque 133 the twist angle W increases again only above the control threshold 130, but does not fall further when the stator wheel supporting torque 133 increases again below the control threshold 130.

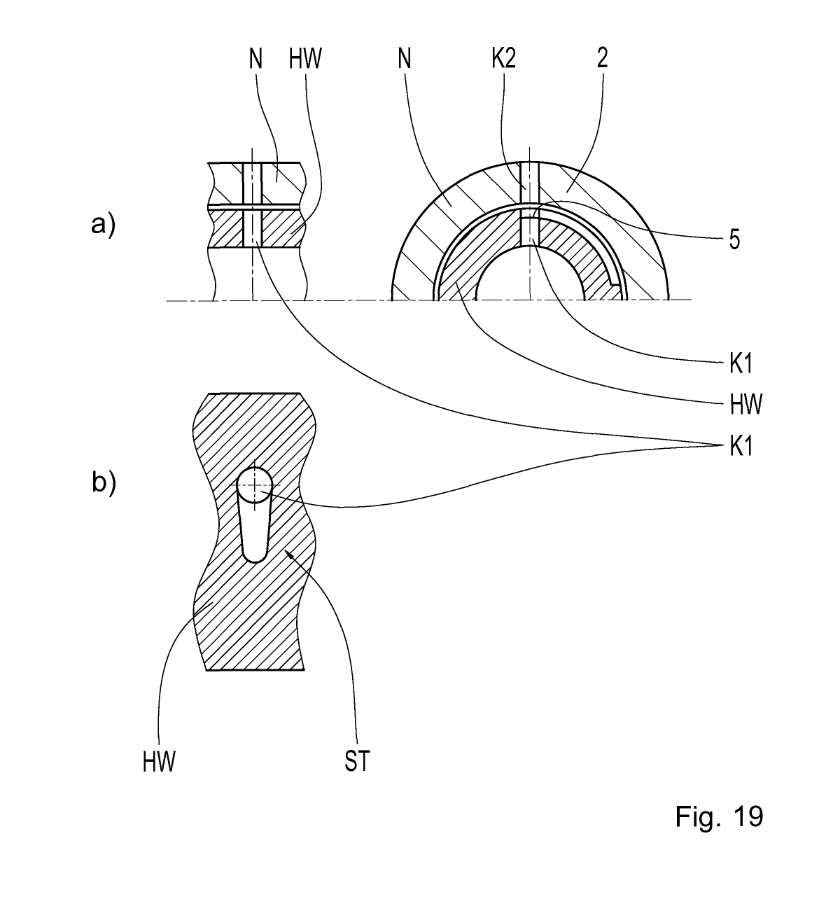

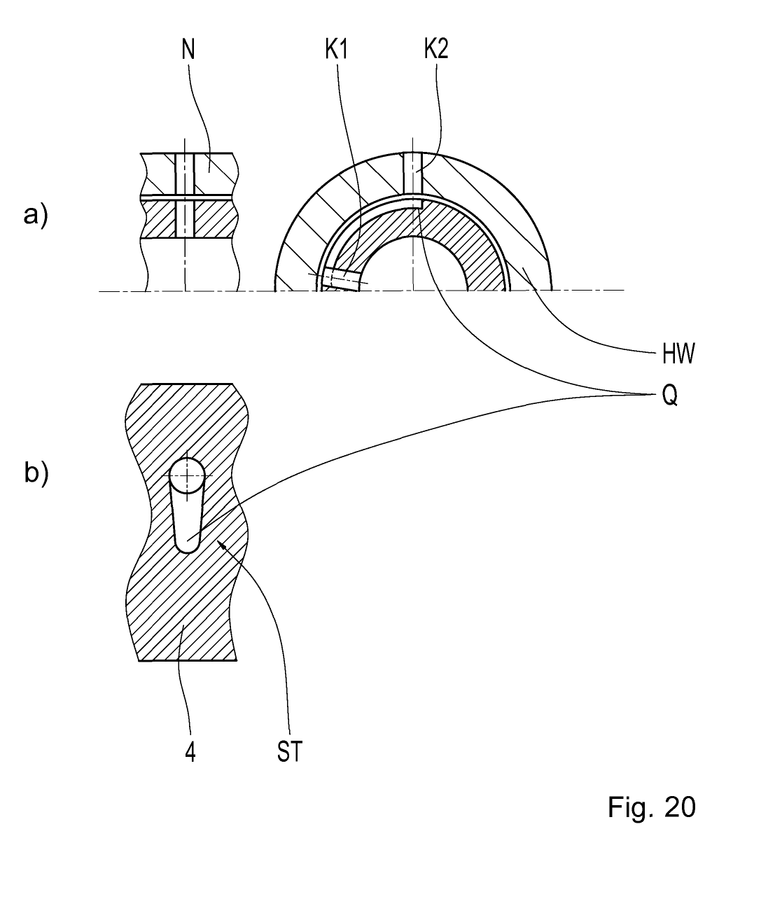

FIGS. 19a-b show a cross section and axial section and angled surface of a hollow shaft with variable cross section for a torque converter device according to a nineteenth embodiment form of the present invention, and FIG. 20 shows a cross section and axial section and angled surface area of the hollow shaft with variable cross section for a torque converter device according to FIG. 19 which is twisted relative to a hub.

A hub N and a hollow shaft HW are shown in FIG. 19a and 19b, respectively. As in FIG. 2. the hollow shaft is mounted so as to be rotatable relative to and in the hub N. In the hollow shaft HW, there is a channel K1 which has on the radial outer side of the hollow shaft HW a passage in the form of a bore hole 5 which is fluidically connected to a channel K2 of the hub N. The bore hole 5 has a variable cross section in circumferential direction of the hollow shaft HW (joint edge in FIG. 19b). When the hollow shaft HW is twisted, the bore hole 5 in the hub H is no longer directly over the passage bore hole in the form of channel K2 but rather is twisted relative to the latter (see FIGS. 20a, b) and, because of the twist angle of the hollow shaft HW relative to the hub N, adjusts a cross section for a hydraulic liquid depending on the twist angle.

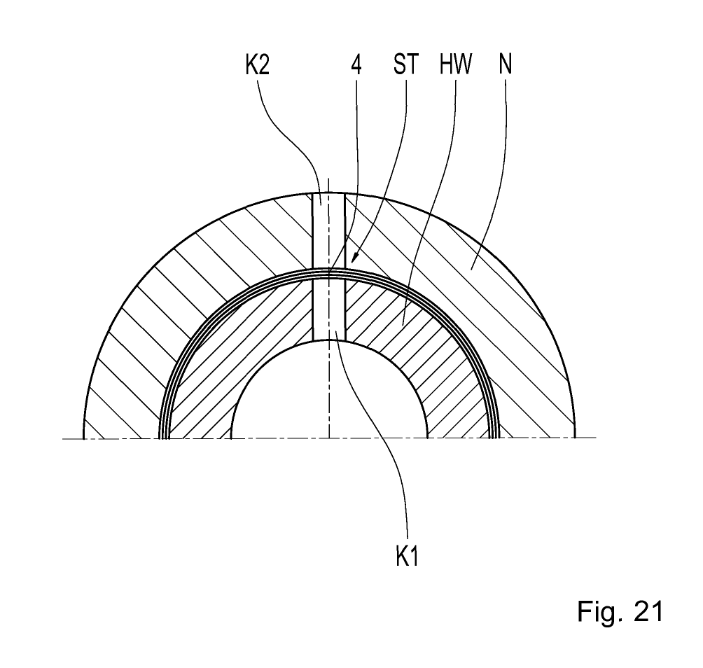

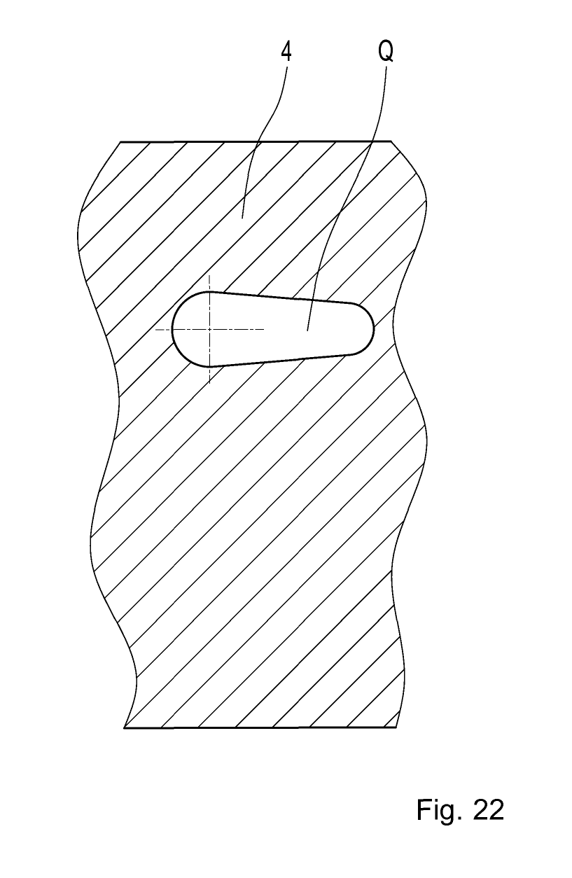

FIG. 21 shows a cross section through a portion of a torque converter device according to a twentieth embodiment form of the present invention, and FIG. 22 shows an angled surface for a portion of the torque converter device according to the twentieth embodiment form of the present invention.

To avoid machining the hollow shafts HW, a diaphragm sleeve 4 can be used and arranged between hub N and hollow shaft HW with corresponding cross-sectional shape (see FIG. 22) analogous to the axial construction. Channels K1, K2 with variable cross section can likewise be arranged in the hub N. Generally, the variable cross-sectional channel can also be carried out axially through an axial displacement of hollow shaft HW relative to hub N, hollow shaft HW relative to diaphragm sleeve 4 or hub N relative to diaphragm sleeve 4.

It is also conceivable that the diaphragm sleeve 4 can allow the cross section Q to be varied through axial movement or in combination with a rotational-translational movement, e.g., a pin, which moves the sleeve 4 over a corresponding curve shape as a result of the rotation of the shaft W in axial direction, e.g., in order to arrive at another cross section characteristic, A further possibility is a rotationally soft shaft that controls a cross section Q through deformation, e.g., a supported shaft or a suitable element or sleeve 4 which also enables or takes over a restoring function in particular. A change in cross section is also possible through this deformation, e.g., a support, so that the cross section of the diaphragm 4 with rising supporting torque is smaller.

In summary, the present invention offers the advantage that it makes possible a coolant oil supply of a torque converter device that meets requirements, is neutral with respect to installation space and is economical. At the same time, a reliable supply of coolant oil to the torque converter device is possible. Beyond this, the power consumption of a transmission oil pump is reduced and the efficiency of the hydraulic supply of the torque converter device or, more broadly, of the transmission can be achieved.

Overall, the present invention provides in particular a stator wheel of a hydrodynamic torque converter supported so as to be angularly rotatable with respect to the transmission housing and can be kept in force equilibrium, e.g., via springs, and a starting position is also accordingly ensured. When starting, i.e., during operation of the torque converter device, torque is generated at the stator wheel which substantially correlates to the differential speed between turbine and pump and accordingly contributes to the power loss. The torque supported by the stator wheel twists the stator wheel counter to the spring force and accordingly enables a defined angular position between the stator wheel and transmission. Therefore, a cross section of the inflow can be configured as a function of the supporting torque in which, for example, a diaphragm with a cross section meeting requirements is released. This allows a cooling which meets demands. As conversion decreases, the supporting torque at the stator wheel decreases and the cross section or diaphragm can be varied continuously or different cross sections can also be assumed, for example, by stages. A resetting device, e.g., spring and stop, ensures the stalling position and also an end position. Further, the lines can be guided to the torque converter device within the shaft and can change the flow direction depending upon state, and only a fixed feed line and discharge line are provided in the transmission.

Although the present invention has been described in terms of preferred embodiment examples, it is not limited to the latter but can be modified in a variety of ways.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-18. (canceled)

19. A torque converter device comprising:
a housing arrangement;
a hydrodynamic device arranged in the housing arrangement the hydrodynamic device comprises:
an impeller wheel connected on an input side to a driveshaft via the housing arrangement;
a turbine wheel connected to an output shaft; and
a stator wheel,
wherein the impeller wheel, the turbine wheel, and the stator wheel collectively form a circuit filled with a liquid, the circuit configured to supplied with liquid by an external supply device,
wherein the torque converter device is configured to actuate at least one flow control element that controls a flow of liquid for the torque converter device in the circuit one of actively and passively based at least in part on a difference in speed between the impeller wheel and the turbine wheel of the hydrodynamic device.

20. The torque converter device according to claim 19, wherein the at least one flow control element is configured to be actuated such that a first liquid flow can be supplied to the hydrodynamic device at a first differential speed and a second liquid flow can be supplied to the hydrodynamic device at a second differential speed, where the first differential speed is higher than the second differential speed and the first liquid flow is larger than the second liquid flow.

21. The torque converter device according to claim 19, wherein the at least one flow control element is configured to be actuated by at least one of a translational and rotational movement of one or more actuating elements of the hydrodynamic device.

22. The torque converter device according to claim 21, wherein at least one of the one or more actuating elements is a stator wheel support for the stator wheel that is twistable at least partially relative to the housing arrangement and that the at least one flow control element can be actuated depending on a twist angle of the stator wheel support relative to the housing arrangement.

23. The torque converter device according to claim 19, wherein the at least one flow control element is configured to provide at least one of a variable cross section and a variable length for the flow of liquid.

24. The torque converter device according to claim 19, wherein the at least one flow control element is constructed as at least one of a slide element, a diaphragm element, and a blocking element.

25. The torque converter device according to claim 24, wherein the slide element is one of disk-shaped, spherical, conical, and cylindrical.

26. The torque converter device according to claim 19, wherein at least one preloading element is arranged for at least one of the at least one flow control element and for the at least one actuating element such that the at least one flow control element is arranged in a defined initial position.

27. The torque converter device according to claim 26, wherein the at least one preloading element is configured to be one of actively and passively actuated at least one of mechanically, hydraulically, and electrically.

28. The torque converter device according to claim 19, wherein at least one of a resetting device and a retaining device is arranged for at least one of the at least one flow control element and the at least one actuating element.

29. The torque converter device according to claim 28, wherein the at least one of resetting device and the retaining device comprises one or more elastic elements configured as at least on of helical springs, leaf springs, and torsion springs.

30. The torque converter device according to claim 28, wherein the retaining device is configured as at least one catch device in a direction-dependent manner.

31. The torque converter device according to claim 19, wherein at least one of external inlets and outlets are arranged for the circuit and the flow of liquid can be at least partially diverted into at least one of the external inlets and outlets by the at least one flow control element.

32. The torque converter device according to claim 19, wherein a damping element is arranged for damping a movement of at least one of the at least one flow control element and the at least one actuating element.

33. The torque converter device according to claim 19, wherein the at least one flow control element is configured to control the flow of liquid in at least one of a radial flow direction and an axial flow direction.

34. The torque converter device according to claim 28, wherein the retaining device is temperature-dependent.

35. The torque converter device according to claim 21, wherein the at least one actuating element and the at least one flow control element are formed in one piece.

36. A method for controlling a liquid circuit of a torque converter device, having
a housing arrangement;
a hydrodynamic device arranged in the housing arrangement, the hydrodynamic device comprises:
an impeller wheel connected on an input side to a driveshaft via the housing arrangement;
a turbine wheel connected to an output shaft; and
a stator wheel,
wherein the impeller wheel, the turbine wheel, and the stator wheel collectively form a circuit filled with a liquid, the circuit configured to supplied with liquid by an external supply device,
wherein the torque converter device is configured to actuate at least one flow control element that controls a flow of liquid for the torque converter device in the circuit one of actively and passively based at least in part on a difference in speed between the impeller wheel and the turbine wheel of the hydrodynamic device,
the method comprising:
determining the difference in speed between the impeller wheel and the turbine wheel of the hydrodynamic device; and
actuating the at least one flow control element that controls the flow of liquid for the torque converter device based at least in part on the determined difference in speed between the impeller wheel and the turbine wheel,
wherein the hydrodynamic device controls the flow of liquid for the torque converter device in the liquid circuit actively and/or passively depending on the difference in speed between the impeller wheel and the turbine wheel.

37. The torque converter device according to claim 34, wherein the retaining device comprises one of a bimetal and a memory metal.
